(19) United States
(12) Patent Application Publication
(10) Pub. No.: US 2025/0094936 A1
(43) Pub. Date: Mar. 20, 2025

(54) Unmanned Aerial Vehicle-Based Semantic Understanding For Structure Inspection

(71) Applicant: Skydio, Inc., San Mateo, CA (US)

(72) Inventors: Adam Parker Bry, Redwood City, CA (US); Hayk Martirosyan, San Francisco, CA (US); Vincent Lecrubier, Lisbon (PT)

(21) Appl. No.: 18/892,296

(22) Filed: Sep. 20, 2024

Related U.S. Application Data
(60) Provisional application No. 63/539,351, filed on Sep. 20, 2023.

(51) Int. Cl. G06Q 10/20; G05D 1/224; G05D 101/15; G05D 105/80; G05D 109/20; G05D 111/10; G06T 7/00; G06V 10/70; G06V 20/17

(52) U.S. Cl. CPC G06Q 10/20; G05D 1/2247; G06T 7/0004; G06V 10/70; G06V 20/17; G05D 2101/15; G05D 2105/89; G05D 2109/20; G05D 2111/10; G06T 2200/24; G06T 2207/10032; G06T 2207/20081

(57) ABSTRACT

An unmanned aerial vehicle (UAV) performs operations to semantically understand components of a structure under inspection. During an exploration inspection of the structure, a camera of the UAV captures images of the structure. Components of the structure are determined based on the images and a taxonomy associated with the structure, for example, using a computer vision process and a machine learning model. A visual representation of the components (e.g., a semantic scene graph, such as a three-dimensional graphical representation of a hierarchical text representation) is generated and output to a user device in communication with the UAV to enable selections, via a graphical user interface output for display at the user device, of ones of the components for further inspection using the UAV.

### CROSS-REFERENCE TO RELATED APPLICATION(S)

This application claims the benefit of U.S. Provisional Application Ser. No. 63/539,351, filed Sep. 20, 2023, the entire disclosure of which is herein incorporated by reference.

### TECHNICAL FIELD

This application generally relates to structure inspection using an unmanned aerial vehicle (UAV), and, more specifically, to semantic three-dimensional (3D) scan systems and techniques for UAV-based semantic understanding for structure inspection.

### BACKGROUND

UAVs are often used to capture images from vantage points that would otherwise be difficult for humans to reach. Typically, a UAV is operated by a human using a controller to remotely control the movements and image capture functions of the UAV. In some cases, a UAV may have automated flight and autonomous control features. For example, automated flight features may rely upon various sensor input to guide the movements of the UAV.

### SUMMARY

Systems and techniques for, inter alia, UAV-based semantic understanding for structure inspection are disclosed.

In some implementations, a method comprises: obtaining images captured using a camera of an unmanned aerial vehicle during an exploration inspection of a structure; determining components of the structure based on the images and a taxonomy associated with the structure; generating a visual representation of the components; and outputting the visual representation of the components to a user device in communication with the unmanned aerial vehicle to enable selections of ones of the components for further inspection using the unmanned aerial vehicle.

In some implementations of the method, determining the components of the structure based on the images and the taxonomy associated with the structure comprises: performing a computer vision process to detect the components within the images; and identifying the components by object type using the taxonomy.

In some implementations of the method, identifying the components by the object type using the taxonomy comprises: using a machine learning model to process the detected components against the taxonomy.

In some implementations of the method, the method comprises: updating the taxonomy based on the detected components using a machine learning model.

In some implementations of the method, the computer vision process includes at least one of object detection or image segmentation.

In some implementations of the method, the visual representation of the components includes a three-dimensional graphical representation of the structure and generating the visual representation of the components comprises: labeling respective portions of the three-dimensional graphical representation of the structure according to information associated with the components.

In some implementations of the method, labeling the respective portions of the three-dimensional graphical representation of the structure according to information associated with the components comprises: annotating a portion of the three-dimensional graphical representation corresponding to a component with an unfavorable status to indicate the unfavorable status.

In some implementations of the method, the visual representation of the components includes a hierarchical text representation of the structure and generating the visual representation of the components comprises: generating the hierarchical text representation of the structure according to an arrangement of the components within the taxonomy.

In some implementations of the method, the method comprises: obtaining, from the user device, user input indicating the selections of the ones of the components within a graphical user interface within which the visual representation of the components is output for display.

In some implementations, a UAV comprises: one or more cameras; one or more memories; and one or more processors configured to execute instructions stored in the one or more memories to: capture one or more images of a structure using the one or more cameras; determine components of the structure based on the images and a taxonomy associated with the structure; and output a visual representation of the components to a user device to enable selections of ones of the components for inspection.

In some implementations of the UAV, the components are detected based on a computer vision process performed against the one or more images and identified by object type using the taxonomy.

In some implementations of the UAV, the one or more processors are configured to execute the instructions to: generate the visual representation of the components based on the determination of the components.

In some implementations of the UAV, the visual representation includes one or both of a three-dimensional graphical representation of the structure or a hierarchical text representation of the structure.

In some implementations of the UAV, user input indicating the selections of the ones of the components is obtained from the user device to configure the unmanned aerial vehicle to perform an inspection of the selected ones of the components.

In some implementations, a system comprises: an unmanned aerial vehicle; and a user device in communication with the unmanned aerial vehicle, wherein the unmanned aerial vehicle is configured to: capture images of a structure during an exploration inspection of the structure; determine components of the structure based on the images and a taxonomy associated with the structure; and output, to the user device, a visual representation of the components to enable selections of ones of the components for further inspection.

In some implementations of the system, the components are determined based on a detection of the components by a computer vision process performed against the images and an identification of object types of the detected components within the taxonomy.

In some implementations of the system, the user device is configured to: render a graphical user interface that outputs the visual representation of the components for display; and obtain, via the graphical user interface, user input indicating the selections of the ones of the components.

In some implementations of the system, the unmanned aerial vehicle is configured to: perform a further inspection of the ones of the components based on the user input.

In some implementations of the system, the unmanned aerial vehicle is configured to: obtain a three-dimensional graphical representation of the structure; and generate the visual representation of the components by labeling respective portions of the three-dimensional graphical representation of the structure.

In some implementations of the system, the unmanned aerial vehicle is configured to: generate the visual representation of the components as a hierarchical text representation of the structure according to an arrangement of the components within the taxonomy.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is an illustration of an example of a UAV system.

FIG. 2A is an illustration of an example of a UAV as seen from above.

FIG. 2B is an illustration of an example of a UAV as seen from below.

FIG. 3 is an illustration of an example of a controller for a UAV.

FIG. 4 is an illustration of an example of a dock for facilitating autonomous landing of a UAV.

FIG. 5 is a block diagram of an example of a hardware configuration of a UAV.

FIG. 6 is a block diagram of an example of a UAV-based semantic understanding system.

FIG. 7 is a block diagram of example functionality of UAV-based semantic understanding software.

FIG. 8A is an illustration of an example of a structure inspected using a UAV.

FIG. 8B is an illustration of an example of a component listed generated according to a UAV-based semantic understanding of the structure.

FIG. 9 is a flowchart of an example of a technique for UAV-based semantic understanding for structure inspection.

FIG. 10 is a flowchart of an example of a technique for determining structure components without pre-existing semantic data.

FIG. 11 is a flowchart of an example of a technique for determining structure components with pre-existing semantic data.

### DETAILED DESCRIPTION

The versatility of UAVs has made their use in structural inspection increasingly common in recent years. Personnel of various industries operate UAVs to navigate about structures (e.g., buildings, towers, bridges, pipelines, and utility equipment) and capture visual media indicative of the statuses and conditions thereof. Initially, UAV inspection processes involved the manual-only operation of a UAV, such as via a user device wirelessly communicating with the UAV; however, automated approaches have been more recently used in which a UAV determines a target structure and performs a sophisticated navigation and media capture process to automatically fly around the structure and capture images and/or video thereof. In some such cases, these automated approaches may involve the UAV or a computing device in communication therewith performing a 3D scan of a target structure to generate a high-fidelity 3D geometric reconstruction thereof as part of an inspection process. For example, modeling of the 3D geometric reconstruction may be provided to a UAV operator to enable the UAV operator to identify opportunities for a further inspection of the structure.

However, these 3D scan approaches, although representing meaningful improvements over more manual and semi-manual inspection processes, may not be suitable in all structure inspection situations. In particular, such approaches generally involve high-fidelity processing and thus use large amounts of input media generate the 3D geometric reconstruction. This ultimately involves the capture of large amounts of images or videos over a relatively long period of time. Moreover, the 3D geometric reconstruction is purely geometric in that the reconstruction resulting from the 3D scan approach is limited to geometries of the structure. In some situations, however, a UAV operator may not need high-fidelity data about all of a structure, but may instead want to focus on details related or otherwise limited to certain components of the structure. Similarly, the UAV operator may want to have a semantic understanding of the structure that goes beyond what geometries can convey. Finally, while a UAV may of course be manually operated to focus only on certain aspects of a structure, such manual operation is often labor intensive, solve, imprecise, and non-deterministic and thus offers limited value.

Implementations of this disclosure address problems such as these using UAV-based semantic understanding approaches for structure inspection. In particular, UAV-based semantic understanding according to the implementations of this disclosure includes a UAV performing an exploration inspection of a structure to capture one or more images of the structure and then using those one or more images along with a semantic artificial intelligence (AI) engine to semantically determine components of the structure. Representations of those components are presented within one or more graphical user interfaces (GUIs) rendered for display at a user device in communication with the UAV to enable a user of the user device to select ones of the components for a further inspection by the UAV. For example, one GUI may include a text-based component list while another may include a 3D graphical representation of the structure with component details indicated therein. The implementations of this disclosure thus address a user experience for UAV operators in which objects in an inspection scene can be semantically identified and labeled according to type and sub-type taxonomy information and thereafter presented to the user to aide in the inspection process for a given structure.

Generally, the quality of a scan (i.e., an inspection or an operation of an inspection) being “semantic” refers to the scan incorporating information and processing to recognize detailed contextual information for a structure and components thereof. In particular, a UAV performing a semantic 3D scan for a structure inspection uses a machine learning model to generate a comprehensive semantic scene graph of components of a structure, either starting from a blank list of components or an empirically (e.g., templatized) determined default list of components. The scene graph information, the arrangement of which is guided using a taxonomy of object types and sub-types, enables the operator of the UAV to identify components of the structure for a further, detailed inspection using the UAV The scene graph information thus readily identifies components of relevance to a given inspection from amongst a generally or near exhaustive listing of components scanned via the first phase inspection. This semantic understanding of structures and components enables valuable automations for UAV-based structure inspections, improving the accuracy of captured data and materially reducing time and media capture requirements of other scan approaches. For example, a semantic understanding of a structure component may indicate to the UAV information about the component (e.g., its type, location, material, etc.) and/or its relationship to the structure and/or other components thereof.

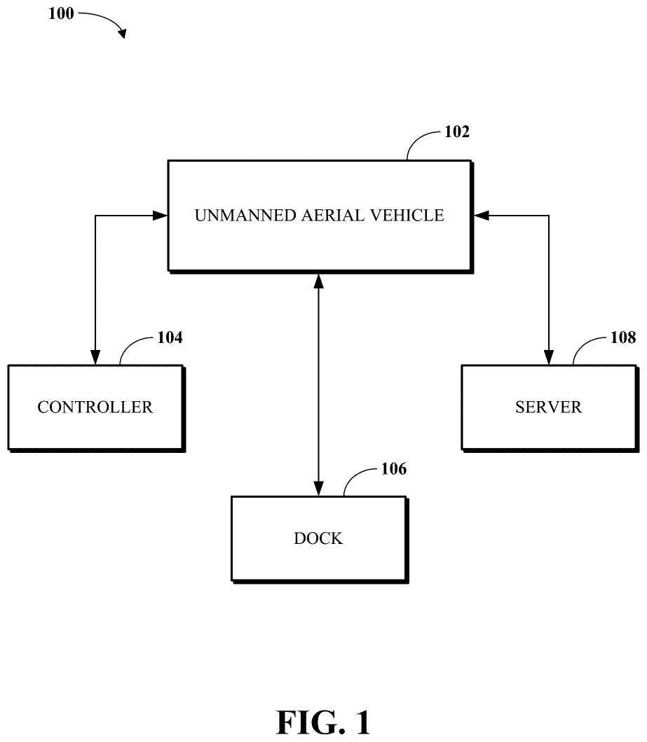

To describe some implementations in greater detail, reference is first made to examples of hardware and software structures used to implement a UAV-based semantic understanding system. FIG. 1 is an illustration of an example of a UAV system 100. The system 100 includes a UAV 102, a controller 104, a dock 106, and a server 108.

The UAV 102 is a vehicle which may be controlled autonomously by one or more onboard processing aspects or remotely controlled by an operator, for example, using the controller 104. The UAV 102 may be implemented as one of a number of types of unmanned vehicle configured for aerial operation. For example, the UAV 102 may be a vehicle commonly referred to as a drone but may otherwise be an aircraft configured for flight within a human operator present therein. In particular, the UAV 102 may be a multi-rotor vehicle. For example, the UAV 102 may be lifted and propelled by four fixed-pitch rotors in which positional adjustments in-flight may be achieved by varying the angular velocity of each of those rotors.

The controller 104 is a device configured to control at least some operations associated with the UAV 102. The controller 104 may communicate with the UAV 102 via a wireless communications link (e.g., via a Wi-Fi network, a Bluetooth link, a ZigBee link, or another network or link) to receive video or images and/or to issue commands (e.g., take off, land, follow, manual controls, and/or commands related to conducting an autonomous or semi-autonomous navigation of the UAV 102). The controller 104 may be or include a specialized device. Alternatively, the controller 104 may be or include a mobile device, for example, a smartphone, tablet, laptop, or other device capable of running software configured to communicate with and at least partially control the UAV 102.

The dock 106 is a structure which may be used for takeoff and/or landing operations of the UAV 102. In particular, the dock 106 may include one or more fiducials usable by the UAV 102 for autonomous takeoff and landing operations. For example, the fiducials may generally include markings which may be detected using one or more sensors of the UAV 102 to guide the UAV 102 from or to a specific position on or in the dock 106. In some implementations, the dock 106 may further include components for charging a battery of the UAV 102 while the UAV 102 is on or in the dock 106. The dock 106 may be a protective enclosure from which the UAV 102 is launched. A location of the dock 106 may correspond to the launch point of the UAV 102.

The server 108 is a remote computing device from which information usable for operation of the UAV 102 may be received and/or to which information obtained at the UAV 102 may be transmitted. For example, the server 108 may be used to train a learning model usable by one or more aspects of the UAV 102 to implement functionality of the UAV 102. In another example, signals including information usable for updating aspects of the UAV 102 may be received from the server 108. The server 108 may communicate with the UAV 102 over a network, for example, the Internet, a local area network, a wide area network, or another public or private network.

In some implementations, the system 100 may include one or more additional components not shown in FIG. 1. In some implementations, one or more components shown in FIG. 1 may be omitted from the system 100, for example, the server 108.

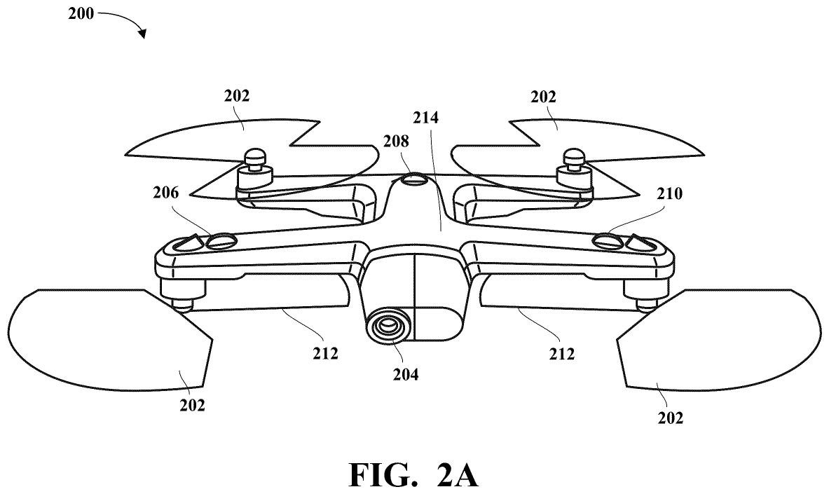

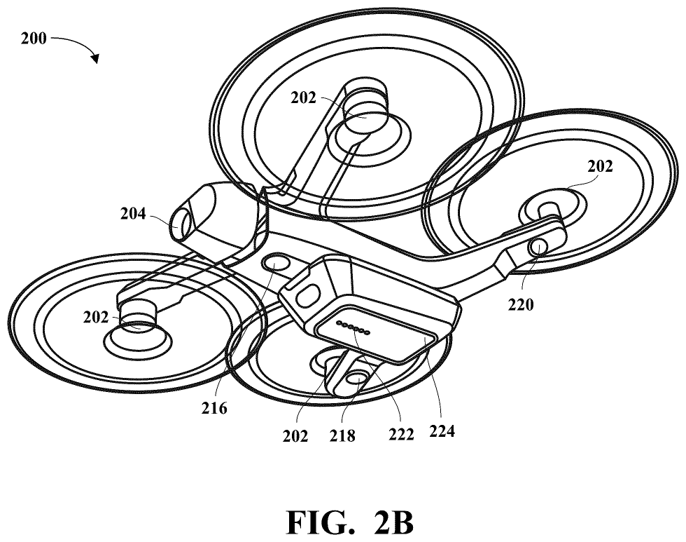

An example illustration of a UAV 200, which may, for example, be the UAV 102 shown in FIG. 1, is shown in FIGS. 2A-B. FIG. 2A is an illustration of an example of the UAV 200 as seen from above. The UAV 200 includes a propulsion mechanism 202 including some number of propellers (e.g., four) and motors configured to spin the propellers. For example, the UAV 200 may be a quad-copter drone. The UAV 200 includes image sensors, including a high-resolution image sensor 204. This image sensor 204 may, for example, be mounted on a gimbal to support steady, low-blur image capture and object tracking. The UAV 200 also includes image sensors 206, 208, and 210 that are spaced out around the top of the UAV 200 and covered by respective fisheye lenses to provide a wide field of view and support stereoscopic computer vision. The image sensors 206, 208, and 210 generally have a resolution which is lower than a resolution of the image sensor 204. Additionally, the UAV 200 includes a number of arms 212 (e.g., four). The propulsion mechanisms 202 may be mounted to the arms 212. The arms 212 are attached the body 214 of the UAV 200. The propulsion mechanisms 202, the arms 212, and the body 214 may collectively be referred to as the frame of the UAV 200. The UAV 200 also includes other internal hardware, for example, a processing apparatus (not shown). In some implementations, the processing apparatus is configured to automatically fold the propellers when entering a dock (e.g., the dock 106 shown FIG. 1), which may allow the dock to have a smaller footprint than the area swept out by the propellers of the propulsion mechanism 202.

FIG. 2B is an illustration of an example of the UAV 200 as seen from below. From this perspective, three more image sensors 216, 218, and 220 arranged on the bottom of the UAV 200 may be seen. These image sensors 216, 218, and 220 may also be covered by respective fisheye lenses to provide a generally wide field of view and support stereoscopic computer vision. The various image sensors of the UAV 200 may enable visual inertial odometry (VIO) for high resolution localization and obstacle detection and avoidance. For example, the image sensors may be used to capture images including infrared data which may be processed for day or night mode navigation of the UAV 200. The UAV 200 also includes a battery in battery pack 224 attached on the bottom of the UAV 200, with conducting contacts 222 to enable battery charging. The bottom surface of the battery pack 224 may be a bottom surface of the UAV 200.

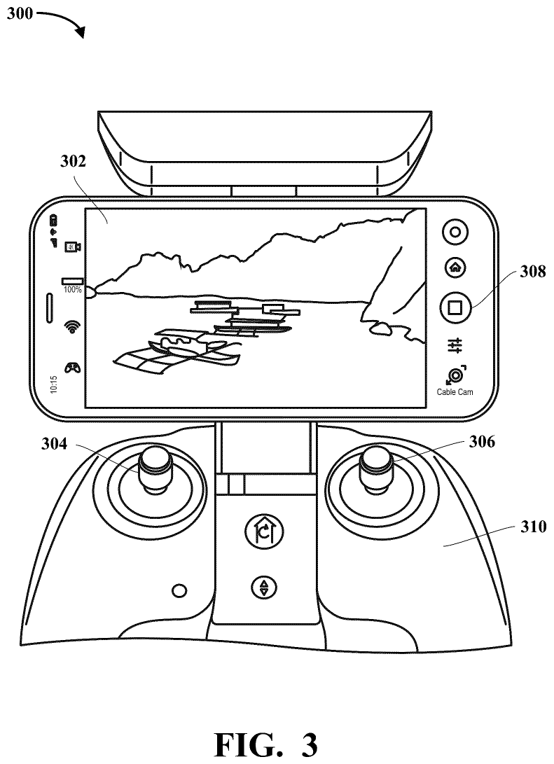

FIG. 3 is an illustration of an example of a controller 300 for a UAV, which may, for example, be the UAV 102 shown in FIG. 1. The controller 300 may, for example, be the controller 104 shown in FIG. 1. The controller 300 may provide a user interface for controlling the UAV and reviewing data (e.g., images) received from the UAV. The controller 300 includes a touchscreen 302, a left joystick 304, and a right joystick 306. In the example as shown, the touchscreen 302 is part of a mobile device 308 (e.g., a smartphone) that connects to a controller attachment 310, which, in addition to providing additional control surfaces including the left joystick 304 and the right joystick 306, may provide range extending communication capabilities for longer distance communication with the UAV.

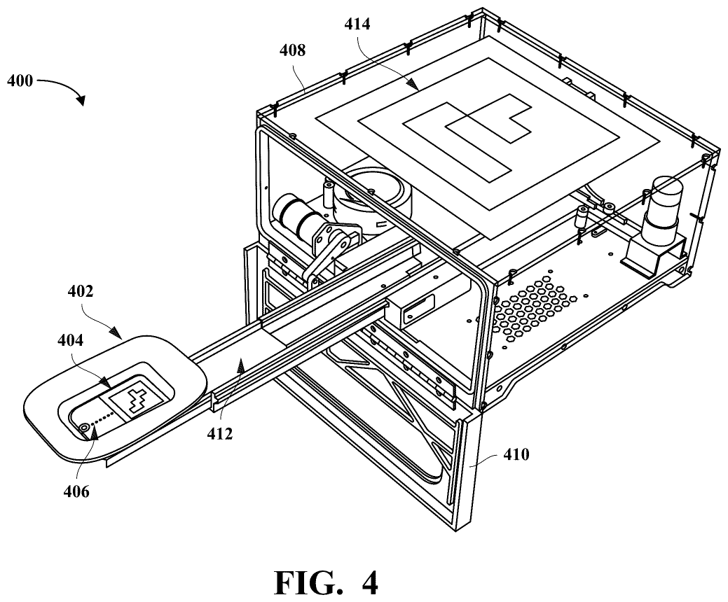

FIG. 4 is an illustration of an example of a dock 400 for facilitating autonomous landing of a UAV, for example, the UAV 102 shown in FIG. 1. The dock 400 may, for example, be the dock 106 shown in FIG. 1. The dock 400 includes a cradle 402 (i.e., landing surface) with a fiducial 404, charging contacts 406 for a battery charger, a box 408 in the shape of a rectangular box with a door 410, and a retractable arm 412.

The cradle 402 is configured to hold a UAV. The UAV may be configured for autonomous landing on the cradle 402. The cradle 402 has a funnel geometry shaped to fit a bottom surface of the UAV at a base of the funnel. The tapered sides of the funnel may help to mechanically guide the bottom surface of the UAV into a centered position over the base of the funnel during a landing. For example, corners at the base of the funnel may serve to prevent the aerial vehicle from rotating on the cradle 402 after the bottom surface of the aerial vehicle has settled into the base of the funnel shape of the cradle 402. For example, the fiducial 404 may include an asymmetric pattern that enables robust detection and determination of a pose (i.e., a position and an orientation) of the fiducial 404 relative to the UAV based on an image of the fiducial 404, for example, captured with an image sensor of the UAV.

The conducting contacts 406 are contacts of a battery charger on the cradle 402, positioned at the bottom of the funnel. The dock 400 includes a charger configured to charge a battery of the UAV while the UAV is on the cradle 402. For example, a battery pack of the UAV (e.g., the battery pack 224 shown in FIG. 2B) may be shaped to fit on the cradle 402 at the bottom of the funnel shape. As the UAV makes its final approach to the cradle 402, the bottom of the battery pack will contact the cradle 402 and be mechanically guided by the tapered sides of the funnel to a centered location at the bottom of the funnel. When the landing is complete, the conducting contacts of the battery pack may come into contact with the conducting contacts 406 on the cradle 402, making electrical connections to enable charging of the battery of the UAV. The dock 400 may include a charger configured to charge the battery while the UAV is on the cradle 402.

The box 408 is configured to enclose the cradle 402 in a first arrangement and expose the cradle 402 in a second arrangement. The dock 400 may be configured to transition from the first arrangement to the second arrangement automatically by performing steps including opening the door 410 of the box 408 and extending the retractable arm 412 to move the cradle 402 from inside the box 408 to outside of the box 408.

The cradle 402 is positioned at an end of the retractable arm 412. When the retractable arm 412 is extended, the cradle 402 is positioned away from the box 408 of the dock 400, which may reduce or prevent propeller wash from the propellers of a UAV during a landing, thus simplifying the landing operation. The retractable arm 412 may include aerodynamic cowling for redirecting propeller wash to further mitigate the problems of propeller wash during landing. The retractable arm supports the cradle 402 and enables the cradle 402 to be positioned outside the box 408, to facilitate takeoff and landing of a UAV, or inside the box 408, for storage and/or servicing of a UAV.

In some implementations, the dock 400 includes a fiducial 414 on an outer surface of the box 408. The fiducial 404 and the fiducial 414 may be detected and used for visual localization of the UAV in relation the dock 400 to enable a precise landing on the cradle 402. For example, the fiducial 414 may encode data that, when processed, identifies the dock 400, and the fiducial 404 may encode data that, when processed, enables robust detection and determination of a pose (i.e., a position and an orientation) of the fiducial 414 relative to the UAV The fiducial 414 may be referred to as a first fiducial and the fiducial 404 may be referred to as a second fiducial. The first fiducial may be larger than the second fiducial to facilitate visual localization from farther distances as a UAV approaches the dock 400. For example, the area of the first fiducial may be 25 times the area of the second fiducial.

The dock 400 is shown by example only and is non-limiting as to form and functionality. Thus, other implementations of the dock 400 are possible. For example, other implementations of the dock 400 may be similar or identical to the examples shown and described within U.S. patent application Ser. No. 17/889,991, filed Aug. 31, 2022, the entire disclosure of which is herein incorporated by reference.

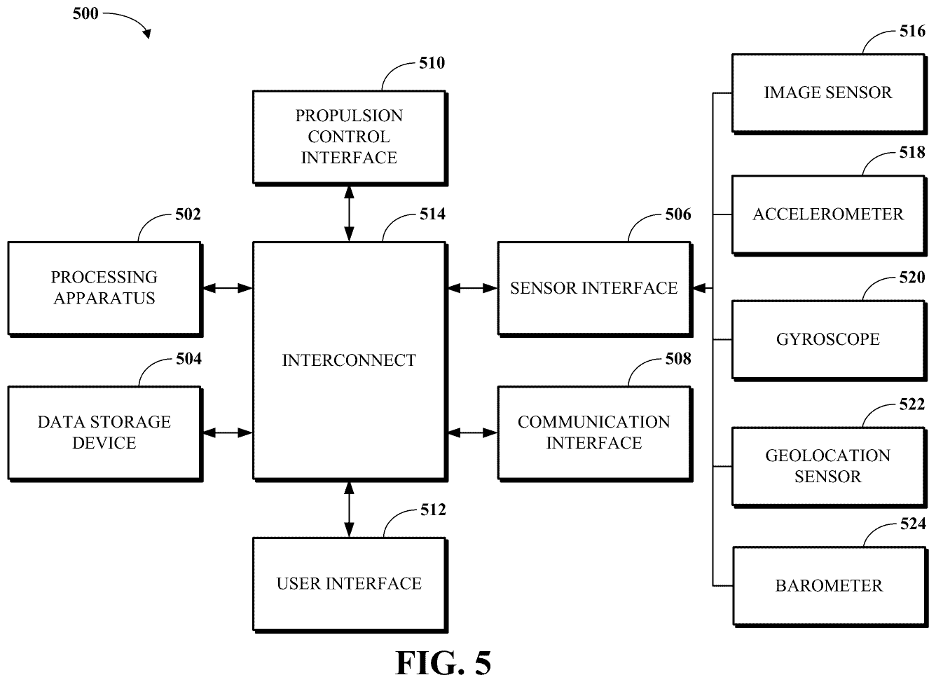

FIG. 5 is a block diagram of an example of a hardware configuration of a UAV 500, which may, for example, be the UAV 102 shown in FIG. 1. The UAV 500 includes a processing apparatus 502, a data storage device 504, a sensor interface 506, a communications interface 508, propulsion control interface 510, a user interface 512, and an interconnect 514 through which the processing apparatus 502 may access the other components.

The processing apparatus 502 is operable to execute instructions that have been stored in the data storage device 504 or elsewhere. The processing apparatus 502 is a processor with random access memory (RAM) for temporarily storing instructions read from the data storage device 504 or elsewhere while the instructions are being executed. The processing apparatus 502 may include a single processor or multiple processors each having single or multiple processing cores. Alternatively, the processing apparatus 502 may include another type of device, or multiple devices, capable of manipulating or processing data. The processing apparatus 502 may be arranged into processing unit, such as a central processing unit (CPU) or a graphics processing unit (GPU).

The data storage device 504 is a non-volatile information storage device, for example, a solid-state drive, a read-only memory device (ROM), an optical disc, a magnetic disc, or another suitable type of storage device such as a non-transitory computer readable memory. The data storage device 504 may include another type of device, or multiple devices, capable of storing data for retrieval or processing by the processing apparatus 502. The processing apparatus 502 may access and manipulate data stored in the data storage device 504 via the interconnect 514, which may, for example, be a bus or a wired or wireless network (e.g., a vehicle area network).

The sensor interface 506 is configured to control and/or receive data from one or more sensors of the UAV 500. The data may refer, for example, to one or more of temperature measurements, pressure measurements, a global positioning system (GPS) data, acceleration measurements, angular rate measurements, magnetic flux measurements, a visible spectrum image, an infrared image, an image including infrared data and visible spectrum data, and/or other sensor output. For example, the one or more sensors from which the data is generated may include single or multiple of one or more of an image sensor 516, an accelerometer 518, a gyroscope 520, a geolocation sensor 522, a barometer 524, and/or another sensor. In some implementations, the accelerometer 518 and the gyroscope 520 may be combined as an inertial measurement unit (IMU). In some implementations, the sensor interface 506 may implement a serial port protocol (e.g., inter-integrated circuit (I2C) or serial peripheral interface (SPI)) for communications with one or more sensor devices over conductors. In some implementations, the sensor interface 506 may include a wireless interface for communicating with one or more sensor groups via low-power, short-range communications techniques (e.g., using a vehicle area network protocol).

The communications interface 508 facilitates communication with one or more other devices, for example, a paired dock (e.g., the dock 106), a controller (e.g., the controller 104), or another device, for example, a user computing device (e.g., a smartphone, tablet, or other device). The communications interface 508 may include a wireless interface and/or a wired interface. For example, the wireless interface may facilitate communication via a Wi-Fi network, a Bluetooth link, a ZigBee link, or another network or link. In another example, the wired interface may facilitate communication via a serial port (e.g., RS-232 or universal serial bus (USB)). The communications interface 508 further facilitates communication via a network, which may, for example, be the Internet, a local area network, a wide area network, or another public or private network.

The propulsion control interface 510 is used by the processing apparatus to control a propulsion system of the UAV 500 (e.g., including one or more propellers driven by electric motors). For example, the propulsion control interface 510 may include circuitry for converting digital control signals from the processing apparatus 502 to analog control signals for actuators (e.g., electric motors driving respective propellers). In some implementations, the propulsion control interface 510 may implement a serial port protocol (e.g., I2C or SPI) for communications with the processing apparatus 502. In some implementations, the propulsion control interface 510 may include a wireless interface for communicating with one or more motors via low-power, short-range communications (e.g., a vehicle area network protocol).

The user interface 512 allows input and output of information from/to a user. In some implementations, the user interface 512 can include a display, which can be a liquid crystal display (LCD), a light emitting diode (LED) display (e.g., an organic light-emitting diode (OLED) display), or another suitable display. In some such implementations, the user interface 512 may be or include a touchscreen. In some implementations, the user interface 512 may include one or more buttons. In some implementations, the user interface 512 may include a positional input device, such as a touchpad, touchscreen, or the like, or another suitable human or machine interface device.

In some implementations, the UAV 500 may include one or more additional components not shown in FIG. 5. In some implementations, one or more components shown in FIG. 5 may be omitted from the UAV 500, for example, the user interface 512.

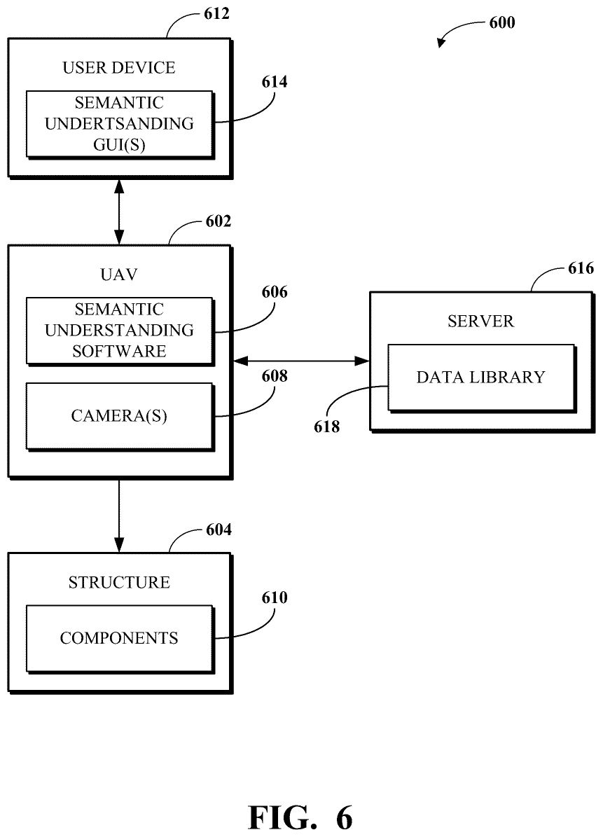

FIG. 6 is a block diagram of an example of a UAV-based semantic understanding system 600. The system 600 includes a UAV 602 and a structure 604 to be inspected using the UAV 602. The UAV 602 may, for example, be the UAV 102 shown in FIG. 1, the UAV 200 shown in FIGS. 2A-B, and/or the UAV 500 shown in FIG. 5. The structure 604 is a physical, 3D structural object that can be wholly or partially flown around by the UAV 602. Non-limiting examples of the structure 604 include buildings (e.g., residential, commercial, or industrial, including internal portions (e.g., warehouse aisles)), bridges (e.g., utility, walkway, or roadway), towers (e.g., powerline transmission, radio, cellular, or water), energy equipment (e.g., sub-stations, wind turbines, solar cells or farms, or power plant cooling towers), vehicles (e.g., aircraft, marine vessels, spacecraft, or land vehicles), civil spaces (e.g., parks or parking lots), and geographic features (e.g., forests, bluffs, mountains, valleys, or ravines). In some cases, the structure 604 may include a living being rather than or in addition to an object as described above. Non-limiting examples of the living being in such a case include humans, animals, fungi, and plants.

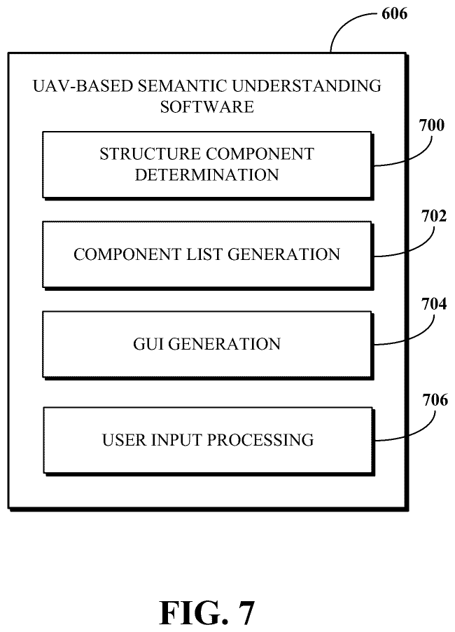

The UAV 602 includes hardware and software that configure the UAV 602 to determine a semantic understanding of the structure 604 via an exploration inspection thereof. In particular, and in addition to other components as are described with respect to FIG. 5, the UAV 602 includes UAV-based semantic understanding software 606 and one or more cameras 608. The UAV-based semantic understanding software 606, which will be described further in connection with FIG. 7, includes functionality for enabling the UAV 602 to perform an exploration inspection of the structure 604 to capture one or more images of the structure 604 using the one or more cameras 608, determine components 610 of the structure 604, and communicate output indicative of the components 610 to a user device 612 via one or more semantic understanding GUIs that are output for display at the user device 612.

The components 610 generally are, include, or otherwise refer to components (e.g., objects, elements, pieces, equipment, sub-equipment, tools, or other physical matter) on or within the structure 604. In one non-limiting example, where the structure 604 is a powerline transmission tower, the components 610 may include one or more of an insulator, a static line or connection point, a conductor or overhead wire, a footer, or a transformer). The structure 604 may include any number of types of the components 610 and any number of ones of the components 610 for each of the individual types thereof.

The output of the exploration inspection of the structure 604 includes at least one or more images, captured using the one or more cameras 608, of the components 610. The output may be communicated to the user device 612 via a user/UAV interface. The user device 612 is a computing device configured to communicate with the UAV 602 wirelessly or by wire. For example, the user device 612 may be one or more of the controller 104 shown in FIG. 1 or the controller 300 shown in FIG. 3. In some cases, the UAV performs the exploration inspection of the structure 604 using input obtained from the user device 612. For example, the input obtained from the user device 612 may include information specifying one or more of the components 610 to inspect, a height at which the UAV 602 will fly while traversing along a flight path, a distance for the UAV 602 to fly, a maximum speed for the UAV 602 to fly, a radius that the UAV 602 will use to orbit or otherwise explore and evaluate the structure 604, a gimbal angle for the one or more cameras 608, a column path for the flight path, an instruction for data capture at waypoints of the flight path, or an instruction for stopping the inspection of the structure 604.

In some cases, the user of the user device 612 may specify one or more configurations for controlling the capture of some or all of the one or more images during the exploration inspection. For example, user input may be obtained from the user device 612 (e.g., via the semantic understanding GUIs 614) to configure the UAV to capture a single image for each component of the structure, to capture N images of the structure each from a different manually-specified or automatically-determined angle (i.e., where N is an integer greater than 1), to capture images from a specified ground sampling distance (GSD) (e.g., using the same GSD for the entire exploration inspection or using different GSDs for different portions of the structure), or the like.

The UAV 602, via the UAV-based semantic understanding software 606, may utilize empirical and/or machine learning-based data modeled for use in structure inspections. In particular, the UAV 602 may communicate with a server 616 that includes a data library 618 usable by the UAV-based semantic understanding software 606 to determine a semantic understanding of the structure 604. The server 616 is a computing device remotely accessible by or otherwise to the UAV 602. The data library 618 may, for example, include one or more of historic inspection data for the structure 604 or like structures, machine learning models (e.g., classification engines comprising trained convolutional or deep neural networks) trained according to inspection image output data sets with user-specific information culled, and/or other information usable by the system 600. In some cases, the data library 618 or other aspects at the server 616 may be accessed by or otherwise using the user device 612 instead of the UAV 602.

To further describe functionality of the UAV-based semantic understanding software 606, reference is next made to FIG. 7, which is a block diagram of example functionality of the UAV-based semantic understanding software 606. The UAV-based semantic understanding software 606, as described above, may use various functionality of a UAV (e.g., the UAV 602 shown in FIG. 6) to cause the UAV to obtain (e.g., generate, determine, etc.) a semantic understanding of a structure under inspection. The UAV-based semantic understanding software 606 includes a structure component determination tool 700, a component list generation tool 702, a GUI generation tool 704, and a user input processing tool 706. The tools 700 through 706 represent various functionality of the UAV-based semantic understanding software 606 and are non-limiting as to a particular structure or other expression of code, script, or the like.

The structure component determination tool 700 determines components on or within the structure to inspect and pose information of the components. During an exploration inspection, the UAV, using one or more cameras thereof, captures one or more images (i.e., exploration images) of the structure while navigating about an exploration path around some or all of the structure. The structure component determination tool 700 obtains, as input, those one or more images captured during the exploration inspection and processes them to determine, as output, components of the structure and the pose information of the components. In particular, the structure component determination tool 700 processes the one or more images captured using the UAV to determine relevant semantics for the components depicted in the one or more images. For example, the structure component determination tool 700 may use an AI engine, such as a classification engine (e.g., a convolutional or deep neural network), to determine semantics such as component type, facet identifier (e.g., based on a triangulation of the component), coordinates, material type, and the like. The output of such processing is metadata with which the respective images may be tagged and which may be indexed for future use with the UAV operator or an entity associated therewith.

The structure component determination tool 700 processes an image captured by the UAV during the exploration inspection to detect one or more objects, as one or more components, within the image and to determine pose information of those one or more components using navigation system information of the UAV Detecting the one or more objects within the image as the one or more components includes performing object detection against the image to identify a bounding box for each component within the image. Objects detected within the image are thus represented via their bounding box, and object recognition is performed against the bounded objects to identify them as components of the structure, as well as to identify what components they are. In some cases, performing object recognition includes comparing objects detected within the images against modeled object data to determine whether an object appears as expected. The objects detected and recognized are identified as components and information indicating the components is stored in connection with the bounding boxes of the components. In some cases, image segmentation may be performed instead of object detection and object recognition. In some cases, other computer vision techniques may be performed instead of either of the above approaches.

The structure component determination tool 700 in particular leverages a taxonomy of structure components by object type and sub-type. For example, the taxonomy may include a hierarchical organization of structures and their components in which known structures for a given component are nested within a level underneath the structure entity and types and variations of those given components are nested underneath the level that shows the components. In some cases, a current state of the taxonomy may be maintained on the UAV or accessed by the structure component determination tool 700 (e.g., from a server, such as the server 616 shown in FIG. 6). In some cases, the taxonomy may instead be generated for use with the structure component determination tool 700 using a machine learning model trained based on structure inspection data. For example, such taxonomies may accordingly in such cases be generated on case-by-case bases using the images captured during respective exploration phases of structures to represent the specific object types and sub-types of those structures, rather than also including object types and sub-types that are irrelevant to those structures. The taxonomy in any case is used to identify names or identifiers of component which may be detected using the structure component determination tool 700.

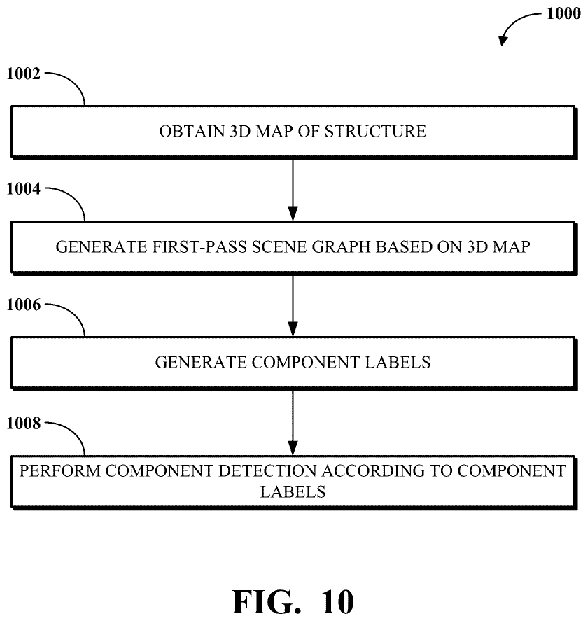

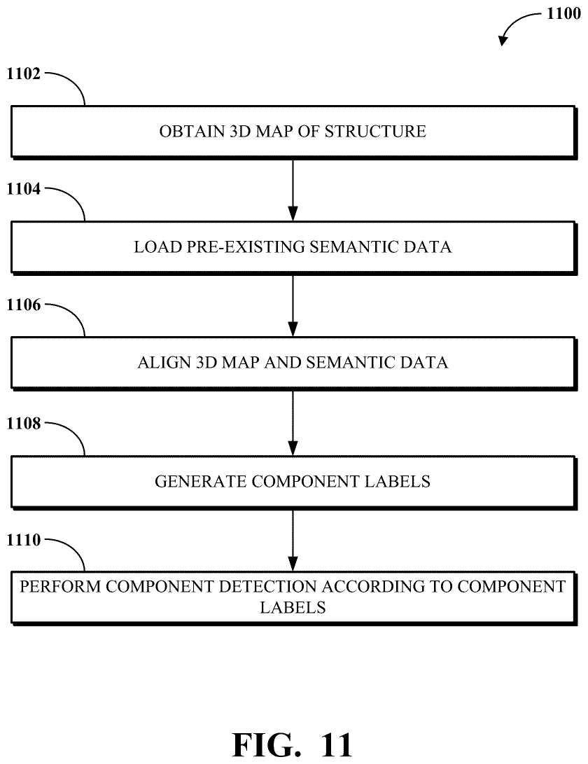

As will be described below with respect to FIGS. 10 and 11, the components may be determined with or without pre-existing semantic data. In some cases, the machine learning model may translate components of the structure to a JavaScript Object Notation (JSON) format readable and usable by other aspects of the UAV-based semantic understanding software 606. In some cases, the components determined for the structure may be represented by the machine learning model as learnt features (e.g., embeddings) rather than in connection with a discrete taxonomy.

Determining the pose information of the one or more components detected within the image using the navigation system information of the UAV includes determining orientations and/or locations of the detected components based on their bounding boxes. The pose information of the components thus corresponds to or otherwise represents the orientations and/or locations of the different components within a scene of the structure. In particular, the pose information of a given component may identify sides, facets, surfaces, or like qualities of the component independently and with relation to others. For example, the pose information may identify a front of a component such that a location of the front of the component may be identifiable. In some cases, the pose information of a component may be based on the type of the component. For example, because inspectors of powerline transmission towers generally need to view insulators from their top and bottom sides, the pose information for an insulator component may include a top pose above the insulator and a bottom pose below the insulator.

Because it is important that objects be uniquely identified to prevent multiple of the same component from being confused as being the same exact component, the structure component determination tool 700, as part of the component and pose information determination, performs a triangulation process to ensure that specific component location information is known. In particular, locations of bounding boxes for detected components may be denoted using location data according to one or more of a visual positioning system (VPS) of the UAV, GPS, or another location-based system. The location data for bounding boxes of the detected components may be compared to determine duplicate components, in which a duplicate component is a component that has already been detected in a previous image. Duplicate components are accordingly culled to prevent them from being considered for scanning multiple times.

In some cases, the structure component determination tool 700 may detect that some object is present within an image captured using the UAV, but may be unable to determine what type of component that object is. In such a case, the structure component determination tool 700 may use a volume rendering technique such as Gaussian splatting to identify the object as a component based on its triangulated location. This volume rendering technique enables the structure component determination tool 700 to determine a location and shape in 3D space of the object. From there, the structure component determination tool 700 may use an AI engine to classify the object according to its location and shape. For example, the AI engine may be a classification engine (e.g., a convolutional or deep neural network) trained to predict object types according to their shapes and relative positionings on structures and nearby other object types. The AI engine may, for example, be trained according to structure and component data determined for historic inspections using UAVs, with user-specific information culled prior to the training.

In some implementations, the structure component determination tool 700 can determine a status of a given component. For example, the status may indicate an operational condition of the component or a damaged or other unfavorable condition of the component. The structure component determination tool 700 may determine the status for a component by using an AI engine, such as a machine learning model trained for image analysis and modeling, to compare a depiction of the component within an image captured using the UAV against operational and unfavorable (e.g., damaged) conditioned versions of like components. Where a component is determined to have an unfavorable condition, the status of the component may be flagged to the user of the user device, for example, for the user to determine whether to select the component for further inspection using the UAV, as described below.

The component list generation tool 702 generates, as a semantic scene graph for the structure, a component list indicating the components determined using the structure component determination tool 700. The components list is generally expressed as a scene-graph hierarchy in which components are represented (e.g., in text) in levels according to their relationship with other components and the structure itself. For example, the hierarchy of the components list may have a number of first level components that each correspond to a different area of the structure, each of the first level components may have a number of second level components that are considered children of the respective first level component, and so on. For example, where the structure is a house, the first level components may be components such as roof, sides (i.e., exterior walls), yards, and the like; the second level components of the roof may be components such as shingles, solar panels, chimneys, and the like; and so on.

In some implementations, the components list may instead be expressed as an object-type hierarchy in which the groupings of levels of the hierarchy, instead of corresponding to areas of the structure, correspond to types of objects. For example, referring again to an example in which the structure is a house, a first level entry of the object-type hierarchy may be windows, second level entries that are children of that first level entry may be different types of windows (e.g., arched, casement, sliding, etc.), and third level entries that are children of individual ones of those second level entries may be the actual components of the structure that were identified within one or more images captured using the UAV. In some implementations, the components list may be separately expressed within both a scene-graph hierarchy and an object-type hierarchy and the user may selectively navigate between them at the user device.

The GUI generation tool 704 generates instructions for rendering one or more GUIs at the user device in communication with the UAV. The GUIs are configured to display information associated with the components listed according to a component list generated using the component list generation tool 702. In particular, the GUI generation tool 704 may generate instructions configured to cause the user device to render a GUI that outputs the component list for display. For example, the GUI to render according to the instructions may output the component list for display in a text format in which entries of the component list (i.e., all components, as in the case of a scene-graph hierarchy, or object type entries and components, as in the case of an object-type hierarchy) are represented in text. In some cases, status information for ones of the components may be included in the component list to indicate, for example, components which may be damaged and thus require further inspection.

The GUI may further include interactive user interface elements. For example, the interactive user interface elements may be checkboxes located proximate to the representations of the components to enable a user of the user device at which the GUI is output for display to interact with ones of the interactive user interface elements to select ones of the components within the GUI. In another example, the interactive user interface elements may include elements for navigating or manipulating the GUI, such as for expanding or collapsing groups of components (e.g., by first level component or entry), switching between GUIs, or modifying content of the GUI (e.g., of the component list), as described below. In some cases, multiple types of these example interactive user interface elements may be concurrently used.

The GUI generation tool 704 may further generate instructions configured to cause the user device to render one or more other GUIs, as well. For example, the GUI generation tool 704 may generate instructions for rendering a GUI which will output for display a graphical representation of the structure in a two-dimensional (2D) or 3D format. The graphical representation of the structure depicts the structure as shown in the one or more images captured using the UAV during the exploration inspection. For example, the GUI generation tool 704 may generate a 3D graphical representation of the structure using a 3D map of the structure obtained as output of a 3D scan or manual flight of the structure and/or using known 3D modeling techniques (e.g., by combining 2D images, generating a point cloud representation, importing known modeling data such as via computer-aided design (CAD) systems, etc.). In another example, the GUI generation tool 704 may generate a 2D graphical representation of the structure either by first generating a 3D graphical representation and then flattening same to a 2D surface or by reconstructing data captured within one of the exploration inspection images. Such a 3D or 2D graphical representation may, along with or in place of the component list described above, be considered a semantic scene graph for the structure under inspection. In some cases, the status of the components may be annotated within the graphical representation of the structure, for example, using coloring, text, highlighting, or another visual manner. In some implementations, the GUI generation tool 704 may generate instructions for the GUI of the graphical representation of the structure instead of a GUI of a component list.

The GUI which includes the graphical representation of the structure may include semantic viewing features for presenting labeled semantic information against the graphical representation. For example, the GUI may enable, via the rendering instructions generated using the GUI generation tool 704, the learning and adaptation of component information to introduce additional structured data within the graphical representation. Non-limiting examples of such structured data may include data obtained from an external modeling system (e.g., a CAD file) associated with the structure or construction plans obtained via an external building system. The structured data may be used by the AI engine to improve semantic understandings of some or all components of the structure, for example, by updating labeling data determined as inconsistent with the structured data.

The user input processing tool 700 obtains and processes input obtained from an operator of the UAV for the semantic understanding of the structure (e.g., the structure 604 shown in FIG. 6). The input includes configuration information for the scan and may be obtained in one or more formats, including free-text, selections from listed options, or the like. For example, the input may include information specifying one or more of objects of interest for the scan (e.g., the components to inspect, such as the components 610 shown in FIG. 6), a height (i.e., altitude) at which the UAV will fly while traversing along a flight path (e.g., between columns of the flight path, as described below), a distance for the UAV to fly from a boundary of the structure, a maximum speed for the UAV to fly (e.g., in miles per hour or kilometers per hour), a radius that the UAV will use to orbit or otherwise explore and evaluate the structure during a first phase inspection of the structure (e.g., in which the radius is larger than the sum of a stand-off distance and half of a dimensional measurement associated with the structure), a gimbal angle for one or more cameras of the UAV (e.g., set for individual objects or universally for all objects, in which the gimbal angle may by default be zero and in which multiple gimbal angles may accordingly be set), a column path for the flight path (e.g., indicating whether to use two or four columns), an instruction for data capture at waypoints of the flight path (e.g., enabling or disabling the automatic image capture at each waypoint of the flight path during autonomous flight), or an instruction for stopping the inspection of the structure (e.g., enabling or disabling the UAV pausing at each waypoint of the flight path during autonomous flight). The user input processing tool 700 processes this input and passes same for use with other tools of the UAV-based semantic understanding software 606 to configure the scan of the structure.

Additional user input may be obtained and processed using the user input processing tool 700 following an exploration inspection of the structure. In particular, one or more GUIs may be rendered at the user device according to instructions generated using the GUI generation tool 704. In one non-limiting example, such a GUI may include a component list generated using the component list generation tool 702. The component list may include individual components or entries each corresponding to a different component type. The components or other entries of the component list may each have a selectable or otherwise interactive element (e.g., a checkbox). When such an interactive element is selected or otherwise interacted, the additional user input is obtained, in which the additional user input indicates an intention of the UAV operator to cause the respective components associated with the subject entry to be inspected during a further inspection of the structure.

In some cases, a user of the user device may modify one or more aspects of a component identified as part of the structure. For example, the structure component determination tool 700 may at some point misidentify a component according to a visual similarity with a different component type or an obfuscation of the component by some other content within an image of the structure. In such a case, the user of the user device may correct the representation of the component via user input obtained and processed using the user input processing tool 706. In another example, the structure component determination tool 700 may accurately identify a component, but the user of the user device may prefer that the component be represented using a different identifier (e.g., due to a policy of a company or other entity with which the user of the user device is associated). In such a case, the user of the user device may change the representation of the component via user input obtained and processed using the user input processing tool 706.

The UAV-based semantic understanding software 606 is shown and described as being run (e.g., executed, interpreted, or the like) at a UAV used to perform an inspection of a structure. However, in some cases, the UAV-based semantic understanding software 606 or one or more of the tools 700 through 706 may be run other than at the UAV. For example, one or more of the tools 700 through 706 may be run at a user device or a server device and the output thereof may be communicated to the UAV for processing. In some cases, the UAV-based semantic understanding software 606 may include other tools beyond the tools 700 through 706. For example, the UAV-based semantic understanding software 606 may include a taxonomy update tool that uses a machine learning model to update a taxonomy used by the structure component determination tool 702 to determine the components of the structure.

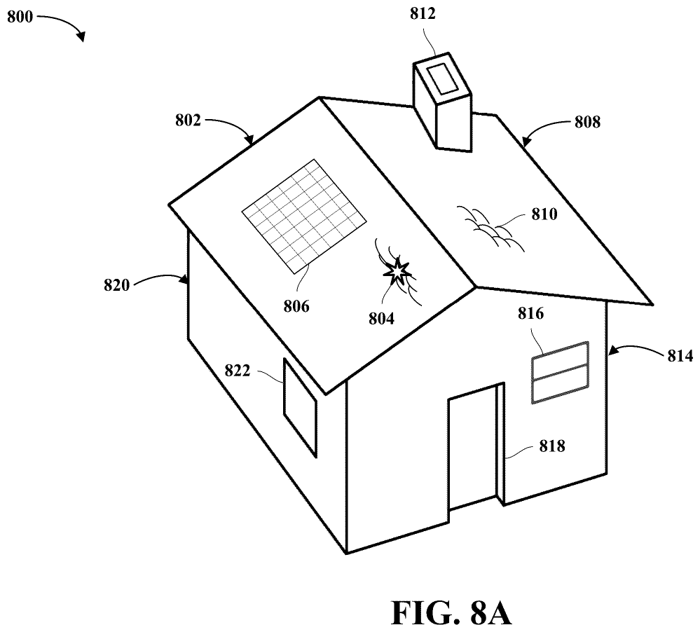

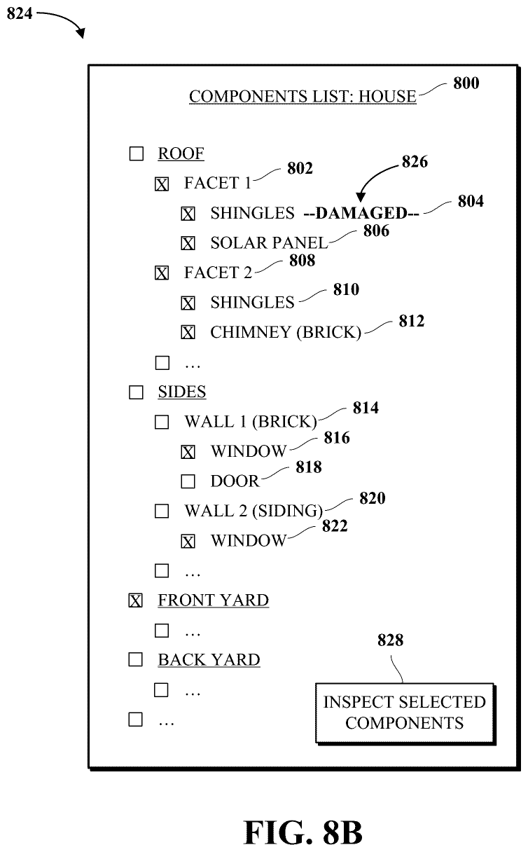

To further describe some implementations in greater detail, reference is next made to examples of illustrations of UAV-based semantic understanding content, which will be referenced in regard to an example use case of the UAV-based semantic understanding system 600 shown in FIG. 6. FIG. 8A is an illustration of an example of a structure 800 inspected using a UAV FIG. 8B is an illustration of an example of a component list 824 generated according to a UAV-based semantic understanding of the structure 800 shown in FIG. 8A.

Referring first to FIG. 8A, the structure 800 is shown by example as a house (i.e., a detached, single-family residence). A UAV (e.g., the UAV 602) takes off in front of the structure 800 and begins capturing a live video feed using one or more cameras thereof. The live video feed is rendered within a GUI output for display a user device in communication with the UAV (e.g., the user device 612). A user of the user device (i.e., an operator of the UAV) initiates an exploration inspection of the structure 800 by the UAV by interacting with a user interface element within the GUI at the user device. The UAV then performs an exploration inspection of the structure 800 by orbiting around the structure 800 one or more times while capturing one or more images of the structure 800. In particular, the UAV captures one or more images depicting each side of the structure 800 to ensure all components of the structure 800 are pictured somewhere. Accordingly, the one or more images will be processed (e.g., using object detection and segmentation) to identify components of the structure 800 including a first roof facet 802 which includes shingles 804 and a solar panel 806, a second roof facet 808 which includes shingles 810 and a chimney 812, a first side wall 814 which includes a window 816 and a door 818, and a second side wall 820 which includes a window 822.

Referring next to FIG. 8B, the components list 824 generated for the structure 800 based on the exploration inspection described above is shown. The components list 824 is a hierarchical representation of the components of the structure 800, determined based on the processing of the one or more images captured during the exploration inspection, and thus shows representations (e.g., text names or like identifiers) for each of those components. As shown, the components list 824 includes representations of each of the components 802 through 822, as shown in FIG. 8A. The components list 824 may further include status information for some or all of the components 802 through 822. In the example shown, damage was detected with respect to the shingles 804 based on the processing of the one or more images depicting the shingles 804. The components list 824 accordingly includes a status identifier 826 indicating a damaged status of the shingles 804. The components list 824 includes interactive user interface elements next to the listed components 802 through 822. In the example shown, the interactive user interface elements are checkboxes. The user of the user device interacts with ones of the interactive user interface elements to select corresponding ones of the components 802 through 822 for the UAV to focus on during a subsequent inspection scan of the structure 800. In some cases, given the hierarchical nature of the components list 824, the selection of a component (e.g., via checking the checkbox associated therewith) will cause an automated selection of any components nested thereunder (i.e., in a next child level of the hierarchy, in which the selected component is considered on a parent level of that child level). In the example shown, the user of the user device has selected the roof facet 1 802, the roof facet 2 808, the window 816, and the window 822, as well as the front yard (for which components are not shown). After selecting the applicable components, the user interacts with a user interface element 828 (e.g., a button) to cause an inspection of the selected components.

In some cases, a graphical representation of the structure 800 showing locations of ones of the components 802 through 822 may be accessed, viewed, and interacted with via the user device. For example, the user of the user device may interact with a representation of a component within the components list 824 to select to view the component on the graphical representation of the structure 800. In doing so, the user device outputs for display the graphical representation with a visual indicator for the component at an applicable location on the structure 800, within the same or a separate GUI as the GUI which outputs the components list 824. The graphical representation of the structure 800 may depict the structure 800 in a 2D or 3D view. In some cases, the user of the user device may interact with a respective component within the graphical representation of the structure 800 to select it for inspection by the UAV as if it had been selected (e.g., had its box checked) in the components list 824. The structure 800 as depicted in FIG. 8A may, for example, correspond to a 3D model or 3D graphical representation of the house described therewith.

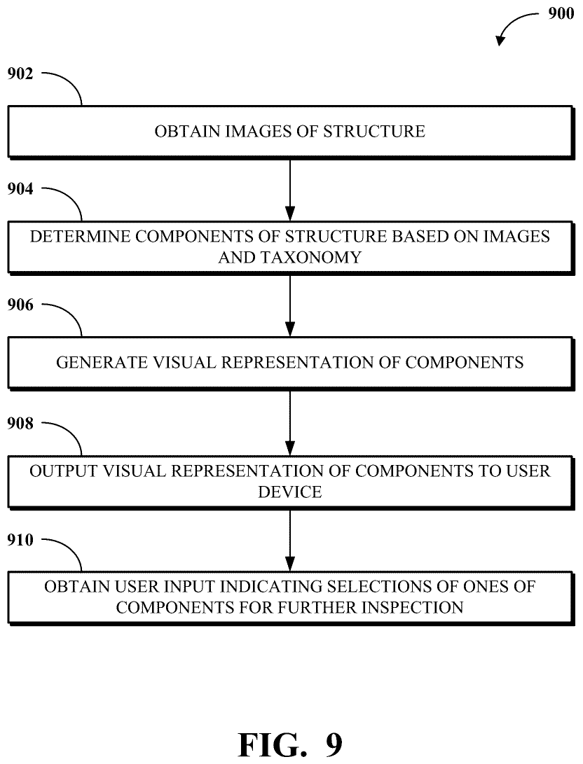

To further describe some implementations in greater detail, reference is next made to examples of techniques for UAV-based semantic understanding. FIG. 9 is a flowchart of an example of a technique 900 for UAV-based semantic understanding for structure inspection. FIG. 10 is a flowchart of an example of a technique 1000 for determining structure components without pre-existing semantic data. FIG. 11 is a flowchart of an example of a technique 1100 for determining structure components with pre-existing semantic data.

The technique 900, the technique 1000, and/or the technique 1100 can be executed using computing devices, such as the systems, hardware, and software described with respect to FIGS. 1-8B. The technique 900, the technique 1000, and/or the technique 1100 can be performed, for example, by executing a machine-readable program or other computer-executable instructions, such as routines, instructions, programs, or other code. The steps, or operations, of the technique 900, the technique 1000, and/or the technique 1100, or another technique, method, process, or algorithm described in connection with the implementations disclosed herein can be implemented directly in hardware, firmware, software executed by hardware, circuitry, or a combination thereof.

For simplicity of explanation, the technique 900, the technique 1000, and the technique 1100 are each depicted and described herein as a series of steps or operations. However, the steps or operations in accordance with this disclosure can occur in various orders and/or concurrently. Additionally, other steps or operations not presented and described herein may be used. Furthermore, not all illustrated steps or operations may be required to implement a technique in accordance with the disclosed subject matter.

Referring first to FIG. 9, the technique 900 for UAV-based semantic understanding for structure inspection is shown. At 902, images of a structure under inspection are obtained. The images are captured using one or more cameras of a UAV during an exploration inspection of the structure. For example, the exploration inspection can include the UAV orbiting around the scene of the structure while capturing the images. Orbiting around the scene may, for example, include the UAV circling the structure, navigating along a perimeter or like boundary of the structure, or otherwise exploring the scene of the structure from a distance. In some cases, the orbiting can follow a zig-zag, lawnmower, or other pattern around the scene of the structure. The orbiting may be performed at one or more altitudes relative to the structure.

At 904, components of the structure are determined based on the images and a taxonomy. Determining the components of the structure includes performing a computer vision process to detect the components within the images and identifying the components by object type using the taxonomy. The computer vision process may, for example, be one or both of object detection or image segmentation. The taxonomy is associated with the structure. For example, the taxonomy may be generically created prior to the exploration inspection of the structure as having relevance to multiple structure types or it may be specifically generated for the inspection of the structure. In either such case, determining the components may include updating the taxonomy based on the detected components (e.g., using a machine learning model, such as a deep learning-based classification model trained based on historical structural inspection data). Where the taxonomy includes pre-existing information associated with a structure type of the structure, determining the components, and, in particular, identifying the components using the taxonomy may include accessing the taxonomy and using a machine learning model trained based on historical structural inspection data, to process the detected components against the taxonomy.

At 906, a visual representation of the components (i.e., a semantic scene graph of the structure) is generated. The visual representation may, for example, be a 3D graphical representation of the structure or a hierarchical text representation of the structure. For example, where the visual representation is a 3D graphical representation of the structure, generating the visual representation may include labeling respective portions of the 3D graphical representation of the structure according to information associated with the components. In another example, where the visual representation is a hierarchical text representation of the structure, generating the visual representation may include generating the hierarchical text representation of the structure according to an arrangement of the components within the taxonomy (e.g., using nested levels of components or other entries). In some cases, multiple visual representations (e.g., a three-dimensional graphical representation of the structure and a hierarchical text representation of the structure) may be generated. In some cases, a status of a component may be indicated within the visual representation. For example, a portion of the 3D graphical representation or a portion of the hierarchical text representation that corresponds to a component with an unfavorable status may be annotated to indicate the unfavorable status.

At 908, the visual representation of the components is output to a user device in communication with the UAV The visual representation is output to the user device to enable selections of ones of the components for further inspection using the UAV. For example, outputting the visual representation to the user device can include transmitting, to the user device, instructions for rendering one or more GUIs at the user device in which the GUIs are configured, based on the instructions, to output the visual representation for display.

At 910, user input indicating selections of ones of the components for further inspection is obtained via the user device. The user input may be obtained via one or more interactive user interface elements or like components of the one or more GUIs output for display at the user device. The user input is obtained to configure the UAV to perform an inspection of the selected ones of the components, in which the inspection focuses on those selected ones of the components. The inspection may, for example, be performed using the UAV according to a flight path determined based on locations of the selected ones of the components. The output of such inspection may, for example, include one or more images of those selected ones of the components.

Referring next to FIG. 10, the technique 1000 for determining structure components without pre-existing semantic data is shown. The technique 1000 may, for example, be performed as or as part of the determination of the components as described above in connection with the technique 900 shown in FIG. 9. At 1002, a 3D map of a structure under inspection is obtained. Obtaining the 3D map of the structure can include generating the 3D map using images captured using a camera of a UAV during an exploration inspection of the structure by the UAV. Alternatively, obtaining the 3D map of the structure can include importing the 3D map (e.g., via a CAD or like system) from an external source or generating the 3D map using data obtained from an external source.

At 1004, a first-pass scene graph of the structure is generated based on the 3D map. The first-pass scene graph is a graphical representation of the structure. For example, the first-pass scene graph may be a graphical representation generated based on the components detected as being of the structure. In particular, generating the first-pass scene graph based on the 3D map includes performing a computer vision process against images captured using the UAV to detect the components of the structure. The computer vision process may, for example, be one or both of object detection or image segmentation.

At 1006, component labels are generated for the scene graph. The component labels are or otherwise include or represent data associated with structure components detected via the computer vision process. For example, a component label may include a name or other identifier for a component or other information usable to identify the component. Generating the component labels can include obtaining user input (e.g., from a user device in communication with the UAV) indicating the content of a label to generate for a content or using a machine learning model (e.g., trained based on historical structure inspection data) to generate such content for a label.

At 1008, component detection is performed against the scene graph according to the component labels. Performing the component detection against the scene graph according to the component labels includes using an AI engine (e.g., a classification-based machine learning model) to determine components to which the component labels apply. For example, where the user input indicating content of a label to generate is received to update the name of a component on a bounding box of that component, the AI engine can automatically detect other instances of that object type and accordingly update labels for those corresponding components. The labeled components of the scene graph may then be output as determined components.

Referring next to FIG. 11, the technique 1100 for determining structure components with pre-existing semantic data is shown. The technique 1100 may, for example, be performed as or as part of the determination of the components as described above in connection with the technique 900 shown in FIG. 9. At 1102, a 3D map of a structure under inspection is obtained. Obtaining the 3D map of the structure can include generating the 3D map using images captured using a camera of a UAV during an exploration inspection of the structure by the UAV. Alternatively, obtaining the 3D map of the structure can include importing the 3D map (e.g., via a CAD or like system) from an external source or generating the 3D map using data obtained from an external source.

At 1104, pre-existing semantic data associated with the structure is loaded into memory (e.g., of a UAV used to perform the technique 1100). The pre-existing semantic data is semantic data that existed for a given structure prior to the initiation of the technique 1100 for the inspection of that structure. The semantic data includes information usable to semantically identify components of the structure. Non-limiting examples of the semantic data may include site plans, development plans, CAD files, or the like. The pre-existing semantic data may be obtained from a server or other device in communication with the UAV.

At 1106, the 3D map of the structure is aligned with the semantic data. Aligning the 3D map with the semantic data includes comparing dimensions, identified components, and like qualities of the 3D map to determine likenesses and differences. Components or dimensions that are different between the 3D map and the semantic data are identified to update the 3D map according to the semantic data.

At 1108, component labels are generated for the aligned 3D map. The component labels are or otherwise include or represent data associated with structure components detected via the computer vision process. For example, a component label may include a name or other identifier for a component or other information usable to identify the component. Generating the component labels for the aligned 3D map can include obtaining user input (e.g., from a user device in communication with the UAV) indicating the content of a label to generate for a content or using a machine learning model (e.g., trained based on historical structure inspection data) to generate such content for a label.

At 1110, component detection is performed according to the component labels. Performing the component detection according to the component labels includes an AI engine (e.g., a classification-based machine learning model) determine components to which the component labels apply. For example, where the user input indicating content of a label to generate is received to update the name of a component on a bounding box of that component, the AI engine can automatically detect other instances of that object type and accordingly update labels for those corresponding components. The labeled components may then be output as determined components.

The implementations of this disclosure can be described in terms of functional block components and various processing operations. Such functional block components can be realized by a number of hardware or software components that perform the specified functions. For example, the disclosed implementations can employ various integrated circuit components (e.g., memory elements, processing elements, logic elements, look-up tables, and the like), which can carry out a variety of functions under the control of one or more microprocessors or other control devices.

Similarly, where the elements of the disclosed implementations are implemented using software programming or software elements, the systems and techniques can be implemented with a programming or scripting language, such as C, C++, Java, JavaScript, assembler, or the like, with the various algorithms being implemented with a combination of data structures, objects, processes, routines, or other programming elements.

Functional aspects can be implemented in algorithms that execute on one or more processors. Furthermore, the implementations of the systems and techniques disclosed herein could employ a number of conventional techniques for electronics configuration, signal processing or control, data processing, and the like. The words “mechanism” and “component” are used broadly and are not limited to mechanical or physical implementations, but can include software routines in conjunction with processors, etc. Likewise, the terms “system” or “tool” as used herein and in the figures, but in any event based on their context, may be understood as corresponding to a functional unit implemented using software, hardware (e.g., an integrated circuit, such as an ASIC), or a combination of software and hardware. In certain contexts, such systems or mechanisms may be understood to be a processor-implemented software system or processor-implemented software mechanism that is part of or callable by an executable program, which may itself be wholly or partly composed of such linked systems or mechanisms.

Implementations or portions of implementations of the above disclosure can take the form of a computer program product accessible from, for example, a computer-usable or computer-readable medium. A computer-usable or computer-readable medium can be a device that can, for example, tangibly contain, store, communicate, or transport a program or data structure for use by or in connection with a processor. The medium can be, for example, an electronic, magnetic, optical, electromagnetic, or semiconductor device.

Other suitable mediums are also available. Such computer-usable or computer-readable media can be referred to as non-transitory memory or media, and can include volatile memory or non-volatile memory that can change over time. A memory of an apparatus described herein, unless otherwise specified, does not have to be physically contained by the apparatus, but is one that can be accessed remotely by the apparatus, and does not have to be contiguous with other memory that might be physically contained by the apparatus.

While the disclosure has been described in connection with certain implementations, it is to be understood that the disclosure is not to be limited to the disclosed implementations but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method, comprising:
obtaining images captured using a camera of an unmanned aerial vehicle during an exploration inspection of a structure;
determining components of the structure based on the images and a taxonomy associated with the structure;
generating a visual representation of the components; and
outputting the visual representation of the components to a user device in communication with the unmanned aerial vehicle to enable selections of ones of the components for further inspection using the unmanned aerial vehicle.

2. The method of claim 1, wherein determining the components of the structure based on the images and the taxonomy associated with the structure comprises:
performing a computer vision process to detect the components within the images; and
identifying the components by object type using the taxonomy.

3. The method of claim 2, wherein identifying the components by the object type using the taxonomy comprises:
using a machine learning model to process the detected components against the taxonomy.

4. The method of claim 2, comprising:
updating the taxonomy based on the detected components using a machine learning model.

5. The method of claim 2, wherein the computer vision process includes at least one of object detection or image segmentation.

6. The method of claim 1, wherein the visual representation of the components includes a three-dimensional graphical representation of the structure and generating the visual representation of the components comprises:
labeling respective portions of the three-dimensional graphical representation of the structure according to information associated with the components.

7. The method of claim 6, wherein labeling the respective portions of the three-dimensional graphical representation of the structure according to information associated with the components comprises:
annotating a portion of the three-dimensional graphical representation corresponding to a component with an unfavorable status to indicate the unfavorable status.

8. The method of claim 1, wherein the visual representation of the components includes a hierarchical text representation of the structure and generating the visual representation of the components comprises:
generating the hierarchical text representation of the structure according to an arrangement of the components within the taxonomy.

9. The method of claim 1, comprising:
obtaining, from the user device, user input indicating the selections of the ones of the components within a graphical user interface within which the visual representation of the components is output for display.

10. An unmanned aerial vehicle, comprising:
one or more cameras;
one or more memories; and
one or more processors configured to execute instructions stored in the one or more memories to:
capture one or more images of a structure using the one or more cameras;
determine components of the structure based on the images and a taxonomy associated with the structure; and
output a visual representation of the components to a user device to enable selections of ones of the components for inspection.

11. The unmanned aerial vehicle of claim 10, wherein the components are detected based on a computer vision process performed against the one or more images and identified by object type using the taxonomy.

12. The unmanned aerial vehicle of claim 10, wherein the one or more processors are configured to execute the instructions to:
generate the visual representation of the components based on the determination of the components.

13. The unmanned aerial vehicle of claim 10, wherein the visual representation includes one or both of a three-dimensional graphical representation of the structure or a hierarchical text representation of the structure.

14. The unmanned aerial vehicle of claim 10, wherein user input indicating the selections of the ones of the components is obtained from the user device to configure the unmanned aerial vehicle to perform an inspection of the selected ones of the components.

15. A system, comprising:
an unmanned aerial vehicle; and
a user device in communication with the unmanned aerial vehicle,
wherein the unmanned aerial vehicle is configured to:
capture images of a structure during an exploration inspection of the structure;
determine components of the structure based on the images and a taxonomy associated with the structure; and
output, to the user device, a visual representation of the components to enable selections of ones of the components for further inspection.

16. The system of claim 15, wherein the components are determined based on a detection of the components by a computer vision process performed against the images and an identification of object types of the detected components within the taxonomy.

17. The system of claim 15, wherein the user device is configured to:
render a graphical user interface that outputs the visual representation of the components for display; and
obtain, via the graphical user interface, user input indicating the selections of the ones of the components.

18. The system of claim 17, wherein the unmanned aerial vehicle is configured to:
perform a further inspection of the ones of the components based on the user input.

19. The system of claim 15, wherein the unmanned aerial vehicle is configured to:
obtain a three-dimensional graphical representation of the structure; and
generate the visual representation of the components by labeling respective portions of the three-dimensional graphical representation of the structure.

20. The system of claim 15, wherein the unmanned aerial vehicle is configured to:
generate the visual representation of the components as a hierarchical text representation of the structure according to an arrangement of the components within the taxonomy.
